(19) United States
(12) Patent Application Publication
(10) Pub. No.: US 2006/0093538 A1
(43) Pub. Date: May 4, 2006

(54) Method and apparatus for controlling nucleation in a dispensing system

(75) Inventors: Malcolm C. Larsen, Port St. Lucie, FL (US); Jean-Paul Mahieu, Port St. Lucie, FL (US)

Correspondence Address: SAND & SEBOLT, AEGIS TOWER, SUITE 1100, 4940 MUNSON STREET, NW, CANTON, OH, 44718-3615, US

(73) Assignee: Liquid Control Corporation, North Canton, OH (US)

(21) Appl. No.: 10/981,324

(22) Filed: Nov. 4, 2004

(51) Int. Cl. B01D 9/00

(52) U.S. Cl. 422/245.1

(57) ABSTRACT

A system and method for controlling the nucleation level of a stream of material such as a polyol resin for forming a polyurethane foam. Temperature and pressure control devices communicate with a stream of nucleated material flowing in a recirculation loop from and into a supply of nucleated material. Continuous density measurements are made of the nucleated material in the recirculation loop and are fed to a controller which regulates the amount of a gas injected into the recirculation loop. A material feed line extends from the recirculation loop to a material dispenser. A material bypass line extends from the dispenser back to the recirculation loop for returning unused nucleated material.

### BACKGROUND OF THE INVENTION

1. Technical Field

The invention relates to dispensing systems, and in particular to a system for dispensing gas nucleated material such as a polyurethane foam. More particularly, the invention relates to such a dispensing system having a recirculating loop of the nucleated material in which the pressure, temperature and density is continuously monitored and controlled.

2. Background Information

Gas nucleation is a term used to describe the process of adding a gas (air) to a material such as a polyol resin, for processing polyurethane foams. The nucleation process has proven especially useful in the process of flexible foams and it is desirable to improve the mix quality or cell structure of the cured foam by accurately controlling the amount of pressurized gas injected into a stream of nucleated material. Test have shown that accurately controlling the fluid pressure in the system will allow for more nucleation and that controlling the temperature will enable nucleation to reach and maintain stabilization quicker. Likewise, controlling the air flow pressure is critical to provide for optimum nucleation. Various prior art devices and systems have been developed for measuring the amount of nucleation and attempting to control the same. However, most of these systems are static-type systems wherein a random sampling takes place and results in the addition of air into the system if required. However, to obtain optimal nucleation and to maintain the required level of nucleation during the dispensing of the nucleated material from the system, as well as, when the dispensing equipment is in an off position, and to avoid delays to re-regulate the level of nucleation, it is desirous to provide for the continuous monitoring and maintaining the required level of nucleation, or density of the nucleated material.

### BRIEF SUMMARY OF THE INVENTION

One aspect of the present invention is to provide a system for dispensing nucleated material, and in particular, for dispensing a polyurethane foam, which includes a recirculating loop which constantly monitors the density level of the nucleated material and regulates the density level or nucleation thereof by injecting additional gas, such as air, into the stream of nucleated material flowing through the recirculating loop.

Another feature is to control the temperature and pressure of the stream of nucleated material flowing in the recirculating loop to enhance the efficiency of the system.

A still further aspect of the invention is to provide a feed loop extending between a material dispenser and the circulation loop for drawing nucleated material from the loop for subsequent dispensing onto an object.

Another feature of the invention is to provide a return line from the dispensing mechanism to the recirculation loop to provide for the return of the nucleated material back into the recirculating loop when the dispensing nozzle is in an off position. This provides for a continuous flow of a highly regulated and accurately controlled nucleated material whether the dispensing nozzle is on or off.

Another aspect of the invention is provided for a controller which receives signals from a device which measures the nucleation level of the material flowing through the circulation loop such as a densiometer, which controller then signals a gas pressure injection device to inject a certain amount of pressurized gas into the nucleated stream of material flowing in the recirculation loop to maintain the desired level of nucleation.

Another feature is to provide a temperature control device in the recirculation loop to control the temperature of the nucleated material flowing therethrough and to provide a device for controlling the pressure of the moving stream of nucleated material in the recirculation loop.

A further feature of the invention is to provide for a material input line connected with a material reservoir containing the nucleated material for feeding additional non-nucleated material such as a polyol resin, into the reservoir as required.

These features and advantages are obtained by the improved system of the present invention, the general nature of which may be stated as including a fluid dispensing system with controlled nucleation comprising a reservoir for containing a supply of nucleated material; a dispensing device for discharging a controlled amount of the nucleated material; a recirculation loop communicating with the nucleated material supply reservoir; a measurement station for measuring the level of nucleation of the material flowing in the recirculating loop; a gas injection station for injecting a gas into the nucleated material flowing in the recirculation loop; a controller communicating with the gas injection station and the measurement station for regulating the amount of gas injected into the recirculation loop at the injection station depending upon the level of nucleation of the nucleated material measured at the measurement station; and a material supply line extending from the recirculation loop to the dispensing device for supplying the nucleated material to the dispensing device.

These features and advantages are further obtained by the improved method of the present invention for controlling nucleation of nucleated material, the general nature of which may be stated as including the steps of providing a supply of the nucleated material; providing a recirculation loop communicating with the supply of nucleated material; measuring the level of nucleation of the stream of nucleated material in the recirculation loop; and injecting gas into the nucleated stream flowing in the recirculation loop to control the level of nucleation of the material stream; and directing a stream of the nucleated material from the recirculation loop to a dispensing device.

### BRIEF DESCRIPTION OF THE DRAWING

A preferred embodiment of the invention, illustrative of the best mode in which Applicants have contemplated applying the principles, is set forth in the following description and is shown in the accompanying drawing.

FIG. 1 is diagrammatic flow diagram of the dispensing system of the present invention.

Similar numbers refer to similar parts throughout the drawings.

### DETAILED DESCRIPTION OF THE INVENTION

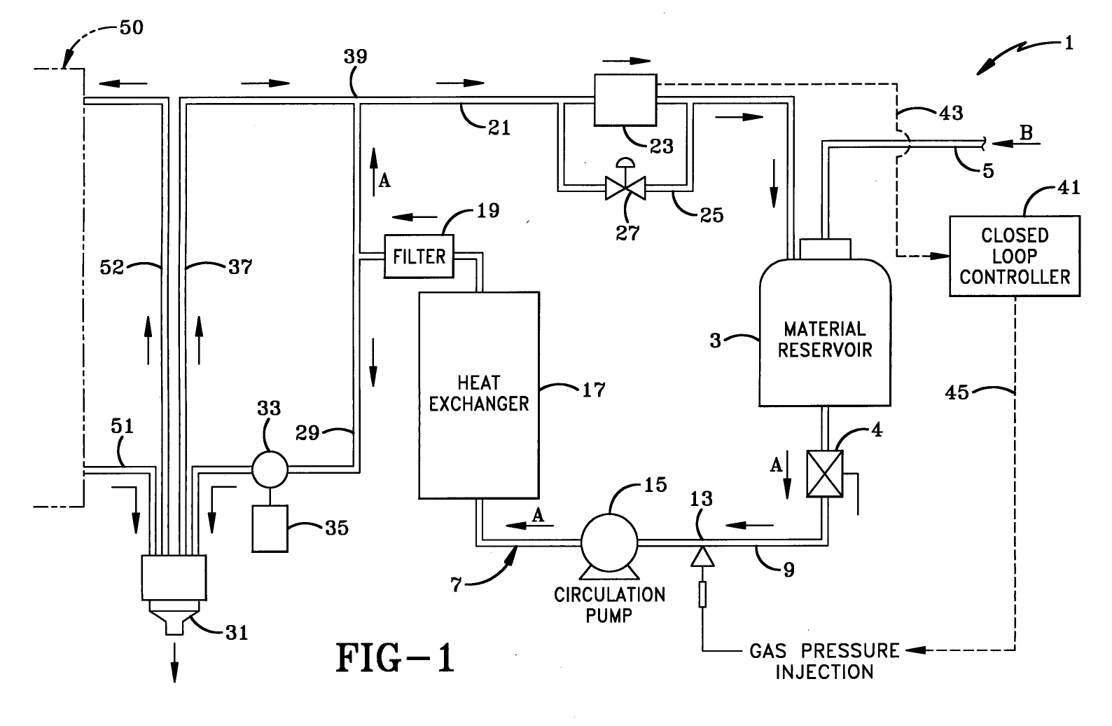

The preferred embodiment of the dispensing system of the present invention is indicated generally at 1, and is shown in FIG. 1. System 1 includes a material reservoir 3 which will contain a quantity of the nucleated material, such as a resin material, such as a polyol resin, and a gas mixture. Non-nucleated resin is fed into reservoir 3 through a feed line 5. The incoming resin is mixed with additional material including a gas, all of which is well known in the polyurethane foaming art, to form the desired nucleated material mixture.

In accordance with one of the main features of the invention, a recirculating loop indicated generally at 7, communicates with material reservoir 3 and includes an outlet line 9 extending from material reservoir 3. Line 9 may contain a manually operated on/off valve 11, a gas pressure injection station 13, a recirculation pump 15, a heat exchanger 17 and a filter 19. Outlet line 9 is connected to a nucleation input line 21 which extends and communicates with material reservoir 3. A density or nucleation measurement device, such a densiometer 23, is mounted in line 21 at a nucleation measurement station, which may include a bypass line 25 and on/off valve 27. A material feed line 29 communicates with circulation loop 7 and extends to a material dispensing mechanism preferably including a dispensing nozzle 31, a metering pump 33 and a drive motor 35 for controlling the flow of material through line section 29 to dispensing nozzle 31 or similar dispensing device.

Furthermore, in accordance with the invention, a bypass or material return line 37 extends from nozzle 31 and connects with material input line 21 at a junction 39. If desired, material bypass/return line 37 could connect directly to material reservoir 3 without connecting to return line 21 at junction 39. In accordance with another feature of the invention, a closed loop controller 41, preferably computer controlled, is connected with densiometer 23 by a signal line 43 and to gas injection station 13 by a signal line 45.

The various equipment discussed above such as the bypass valves, gas injection device of station 13, circulation pump 15, heat exchanger 17, dispenser 31, densiometer 23, nozzle 31, pump 33, drive motor 35, controller 41 are all pieces of equipment well known to those skilled in the material-dispensing art, and thus are not described in further detail.

The operation of the system of the present invention is as follows. Material reservoir 3 will contain a desired amount of a nucleated material formed of various materials such as a polyol resin, used for making a polyurethane foam. Circulation pump 15 continuously circulates the nucleated material as indicated by Arrows A, from reservoir 3 through flow lines 9 and 21 of recirculation loop 7, providing a continuous flow loop from an outlet end of reservoir 3 into line 9 back into an input side of reservoir 3 through line 21. A quantity of the nucleated material is fed from recirculation loop 7 by line 29 to the dispensing mechanism. Usually the amount of nucleated material fed through line 29 to metering pump 33 will be greater than that required to be dispensed from nozzle 31, ensuring that an adequate, properly nucleated amount of material is always present at metering pump 33 of the dispensing mechanism for subsequent delivery of a controlled amount to nozzle 31. When nozzle 31 is in an off position, the nucleated material is returned through lines 37 and 21 back into material reservoir 3. If desired, line 37 could connect directly to reservoir 3 without connecting to line 21.

Closed loop controller 41 preferably receives a continuous signal from densiometer 23 or other type of device which measures the density, specific gravity, or amount of nucleation of the material flowing through loop 7. If the amount of nucleation is not at a desired level, controller 41 will send a signal through line 45 to gas injection station 13 to control the amount of air injected into the nucleated material stream flowing in line 9. The injected gas can be various types of an inert gas, but preferably will be filtered air. Circulation pump 15, which controls the pressure of the nucleated material stream will also ensure a good mixing of the injected gas with the nucleated material stream.

The nucleated material stream being recirculated in loop 7 will pass through heat exchanger 17 or other type of temperature control device which will measure the temperature of the material stream and maintain it at a desired level. It has been found that maintaining the pressure of the nucleated fluid stream and the temperature thereof, assists in controlling and maintaining the proper nucleation thereof.

The non-nucleated material indicated by Arrow B, will be fed into material reservoir 3 as needed through line 5. If desired, controller 41 can be connected to a feed device (not shown) connected to line 5 for feeding the non-nucleated resin into reservoir 3, to circulation pump 15, and to heat exchanger 17 to assist in controlling these various components of the system.

In one application, the particular system shown in FIG. 1, is one half of a two component dispensing system, the other half being similar to system 1 as shown by dot-lines 50, in which a second component is fed through line 51 to dispensing nozzle 31 to provide the second component of the two-component system, which are mixed together before being dispensed by nozzle 31. A return line 52 similar to return line 37 will extend from nozzle 31 to its own material reservoir and recirculation loop.

Preferably, the amount of nucleated material flowing through the recirculation loop 7 will be considerably greater than the amount of material being supplied to the dispensing mechanism through line 29. This enables the nucleation to be maintained at the desired level more easily since it is less affected by the removal of material from loop 7 through line 29 to the dispensing mechanism. Likewise, the return of the non-dispensed nucleated material through line 37 back into the recirculation loop has less effect on the overall level of nucleation in the system due to this smaller returned quantity mixing with a much larger quantity. In one embodiment the nucleated material will have a flow rate of 15 gal./minute in recirculation loop 7 and a dispense rate of 0.1 gal./minute from dispensing nozzle 31.

In summary, the system and method of the present invention provides for the continuous monitoring and control of nucleated material at a desired level of nucleation, with the flow stream being at the desired pressure and temperature than heretofore possible with systems which periodically measured the nucleation and adjusted it accordingly.

It is readily understood that other types of apparatus and materials can be used than that described above and that various pieces of equipment such as valves 11 and 27, and filter 19 could be eliminated or changed without affecting the concept of the invention. Likewise, closed loop controller 41 can be various types of control equipment for adjusting the amount of gas entering the system at station 13 based upon the measurements taken by densiometer 23 or other type of equipment for measuring the specific gravity, density or nucleation of the material flowing in recirculation loop 7.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A fluid dispensing system with controlled nucleation comprising:
a reservoir for containing a supply of nucleated material;
a dispensing device for discharging a controlled amount of the nucleated material;
a recirculation loop communicating with the nucleated material supply reservoir;
a measurement station for measuring the level of nucleation of the material flowing in the recirculating loop;
a gas injection station for injecting a gas into the nucleated material flowing in the recirculation loop;
a controller communicating with the gas injection station and the measurement station for regulating the amount of gas injected into the recirculation loop at the injection station depending upon the level of nucleation of the nucleated material measured at the measurement station; and
a material supply line extending from the recirculation loop to the dispensing device for supplying the nucleated material to said dispensing device.

2. The system defined in claim 1 including a circulation pump mounted in the recirculation loop downstream of the gas injection station for mixing and metering the flow of nucleated material.

3. The system defined in claim 1 including a temperature control device communicating with the recirculation loop for regulating the temperature of the nucleated material flowing in said loop.

4. The system defined in claim 3 wherein the temperature control device is a heater located downstream of the gas injection station.

5. The system defined in claim 1 including a shutoff valve in the recirculation loop between the material supply and gas injection station; and a bypass valve at the nucleation measurement station.

6. The system defined in claim 1 wherein the density measurement station includes a densitometer for measuring the density of the nucleated material.

7. The system defined in claim 1 including a material return line extending from the dispenser to the recirculation loop.

8. The system defined in claim 1 wherein the reservoir contains a supply of nucleated material including a polyol resin and gas mixture for processing polyurethane foam.

9. The system defined in claim 1 wherein the injected gas is air.

10. The system defined in claim 1 including a resin supply line communicating with the reservoir for supply non-nucleated resin into said supply of nucleated material.

11. A method of controlling nucleation of a stream of nucleated material including the steps of:
a) providing a supply of the nucleated material;
b) providing a recirculation loop communicating with the supply of nucleated material;
c) measuring the level of nucleation of the stream of nucleated material in the recirculation loop; and
d) injecting gas into the nucleated stream flowing in the recirculation loop to control the level of nucleation of the material stream; and
e) directing a stream of the nucleated material from the recirculation loop to a dispensing device.

12. The method defined in claim 11 including the step of regulating the temperature of the nucleated stream in the recirculation loop.

13. The method defined in claim 12 including the step of passing the nucleated stream through a heater to regulate the temperature thereof.

14. The method defined in claim 11 including the step of passing the stream of nucleated material in the recirculation loop through a circulation pump for mixing the injected gas into the nucleated stream.

15. The method defined in claim 11 including the step of feeding non-nucleated material into the supply of nucleated material.

16. The method defined in claim 11 including the steps of bypassing the dispensing device with the stream of nucleated material; and returning the bypassed nucleated material into the supply of nucleated material.

17. The method defined in claim 11 including the step of regulating the pressure of the nucleated material flowing in the recirculation loop.

18. The method defined in claim 17 wherein the step of injecting the gas into the nucleated stream occurs upstream of the location where the pressure of the nucleated material is regulated.

19. The method defined in claim 11 including the steps of:
providing a controller;
feeding a signal to the controller of the level of nucleation measured in the recirculation loop;
sending a signal to a gas injection device communicating with the recirculation loop; and
controlling the amount of gas injected into the nucleated stream by the level of nucleation measured in the recirculation loop.

20. The method defined in claim 11 including the step of supplying nucleated material to the dispensing device; and returning an unused amount of the nucleated material to the supply of nucleated material.

21. The method defined in claim 11 including the step of forming the nucleated material of a mixture including polyol resin and pressurized air.
